(19) United States
(12) Patent Application Publication
(10) Pub. No.: US 2002/0148762 A1
(43) Pub. Date: Oct. 17, 2002

(54) Wastewater treatment plant and method for constructing same

(76) Inventor: Jerry L. McKinney, Lumberton, TX (US)

Correspondence Address: Browning Bushman, Suite 1800, 5718 Westheimer, Houston, TX, 77057-5771, US

(21) Appl. No.: 09/833,175

(22) Filed: Apr. 11, 2001

(51) Int. Cl. B01D 35/00

(52) U.S. Cl. 210/205

(57) ABSTRACT

A wastewater treatment plant having a base and a series of wall structures supported on the base, various wall structures or portions thereof together with portions of the base forming separate clarification, aeration, and holding chambers, the walls being constructed of concrete blocks and mortar, there being an inlet into the settling chamber, a conduit forming an outlet from the settling chamber and an inlet into the aeration chamber, a partition disposed and supported in the aeration chamber to form a clarification chamber, and an outlet communicating from the interior of the clarification chamber, either to an optionally provided holding chamber or to the environment, the wastewater treatment plant being installed by forming an excavation in the earth, laying a base, and constructing the various walls.

### BACKGROUND OF THE INVENTION

1. Field of the Invention

The present invention relates to wastewater treatment plants and a method for constructing same. More particularly, the present invention relates to a wastewater treatment plant that can be constructed at remote or underdeveloped sites.

2. Description of the Prior Art

Wastewater treatment plants are commonly used in the United States in areas where there is a lack of municipal sewerage treatment and disposal. Almost invariably, these wastewater treatment plants are either essentially self-contained units that require a minimal amount of plumbing to install or are comprised of relatively large components that have to be assembled on site; however, in either case, these prior art wastewater treatment plants pose transportation and handling problems during installation because of their bulk and/or weight. This problem is exacerbated in underdeveloped and developing countries where the infrastructure is poor, roads are sparse, and transportation and handling equipment is essentially nonexistent. Nonetheless, there is across-the-board recognition that for health and environmental reasons, the installation of wastewater treatment plants to deal with human waste is vital.

It would clearly be desirable to have a wastewater treatment plant wherein the components, for the most part, could be made on site using almost exclusively manual labor to minimize the necessity for expensive and often inaccessible handling equipment, such as forklifts or the like.

### SUMMARY OF THE INVENTION

It is therefore an object of the present invention to provide a wastewater treatment plant for residential or small business usage made primarily of components that are easy to transport and handle, or can be made on site.

Another object of the present invention is to provide a wastewater treatment plant that for the most part can be constructed using only manual labor.

A further object of the present invention is to provide a method of constructing a wastewater treatment plant at the use site.

The above and other objects of the present invention will become apparent from the drawings, the description given herein, and the appended claims.

In one aspect, the present invention provides a wastewater treatment plant comprising a base and a series of wall structures supported on the base. Various of the wall structures or portions thereof, together with portions of the base, form a settling chamber and an aeration chamber. Optionally, the wastewater treatment plant includes a holding chamber for treated wastewater, the holding chamber also being formed by a portion of the base and suitable wall structures supported on the base. The wall structures are constructed of concrete blocks and mortar. There is an inlet into the settling chamber for introducing raw, untreated wastewater into the settling chamber. There is a conduit or another form of open communication between the settling chamber and the aeration chamber, the conduit providing an outlet from the settling chamber and inlet into the aeration chamber. An aeration source is provided in the aeration chamber, generally adjacent the base and a wall structure. Disposed and supported in the aeration chamber is a partition in the shape of an inverted frustoconical hopper, the interior of the hopper or partition forming a clarification chamber. An outlet communicates from the interior of the clarification chamber either to the optionally provided holding chamber or the environment. There is a cover over the settling chamber and over the aeration chamber and, if provided, over the holding chamber.

In another aspect of the present invention, there is provided a method of constructing a wastewater treatment plant much as described above, the method comprising installing a base and suitable walls, as described above, to form the desired chambers, e.g., settling chamber, the aeration chamber, and optionally, the holding chamber. In the method of the present invention, the walls are constructed from concrete blocks and mortar. The method further includes providing an inlet into the settling chamber; providing open communication or a conduit between the settling chamber and the aeration chamber; providing an aeration source in the aeration chamber adjacent the base and one of the wall structures; disposing and supporting a partition in the aeration chamber, the partition forming a clarification chamber having an inverted frustoconical configuration; providing an outlet from the clarification chamber; and installing a cover over the settling and aeration chambers and optionally, a holding chamber.

### BRIEF DESCRIPTION OF THE DRAWINGS

FIG. 1 is an elevational view, partly in section, showing a wastewater treatment plant in accordance with the present invention;

FIG. 2 is a plan view taken along the lines 2-2 of FIG. 1;

FIG. 3 is a cross-sectional view taken along the lines of 3-3 of FIG. 1;

FIG. 4 is a plan view showing one form of a fillet placed in the corner of the aeration chamber;

FIG. 5 is a partial, elevational view of another form of fillet placed in the aeration chamber; and

FIG. 6 is yet another form of a fillet placed in a corner of the aeration chamber.

### DESCRIPTION OF THE PREFERRED EMBODIMENTS

The present invention is directed to a wastewater treatment plant subject to daily flow rates of under 5,000 gallons. While the invention will be described with respect to a subterraneous wastewater treatment plant, it is not so limited.

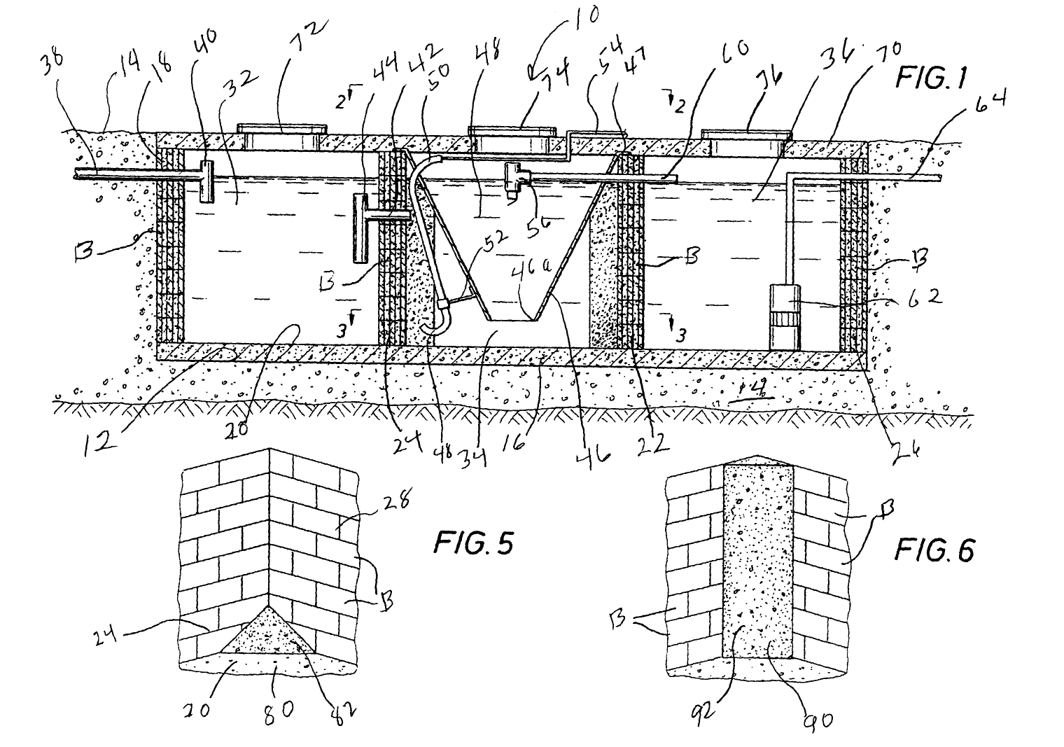

With reference first to FIG. 1, the wastewater treatment plant shown generally as 10 is positioned in an excavation 12 formed in the earth 14, the top of the wastewater treatment plant 10 being generally at about the surface 14 of the earth in which the subterraneous wastewater treatment plant is disposed. Positioned in the excavation 12 is a base 16 that is conveniently formed by pouring a concrete slab but that could be constructed of bricks or other ceramic- or cementitious-type construction materials, e.g., concrete blocks and mortar. A first wall 18 built of concrete blocks B and mortar is supported on the upwardly facing floor surface 20 of base 16. A second wall 22, spaced from wall 18 and likewise made of concrete blocks B and mortar, is positioned on the surface 20 of base 16. An intermediate or partition wall 24, also made of concrete blocks B and mortar, is positioned between first wall and 18 and second wall 22 and disposed on surface 20 of base 16. A third wall 26, likewise made of concrete blocks B and mortar, is installed on base 16, walls 18 and 26 effectively forming end walls of the wastewater treatment plant 10 in the optional case when a holding tank or chamber for treated wastewater is desired.

As best seen with reference to FIG. 3, there is a first side wall 28 which extends between walls 18 and 26 and which is sealingly connected to walls 18, 22, 24 and 26. A second side wall 30 likewise extends between walls 18 and 26 and is sealingly connected to walls 18, 22, 24 and 26. It can thus be seen that a portion of base 16, wall 18, wall 24, and portions of side walls 28 and 30 form a first or settling chamber 32 while a portion of base 16 and walls 24 and 22, in cooperation with portions of side walls 28 and 30, form a second or aeration chamber 34. Lastly, and in the optional case, walls 22 and 26 cooperate with a portion of base 16 and portions of side walls 28 and 30 to form a holding chamber 36. It is to be understood that the various joints between the respective walls and the base are sealed in a suitable fashion with a suitable sealant, e.g., mortar, caulking, silicone or the like to make the respective chambers essentially watertight.

A conduit 38 extends through wall 18 and terminates in a T-head 40 in chamber 32, conduit 38 serving as an inlet for raw, untreated wastewater to be conveyed into settling tank 32. Extending through wall 24 is a conduit 42, conduit 42 providing open communication between chambers 32 and 34 and terminating in a T-head 44 in chamber 32, as is done in the well known fashion. Accordingly, as solids introduced with the wastewater via line 38 into chamber 32 settle to the bottom of chamber 32, the largely clarified water passes through T-head 44 and conduit 42 to aeration chamber 34.

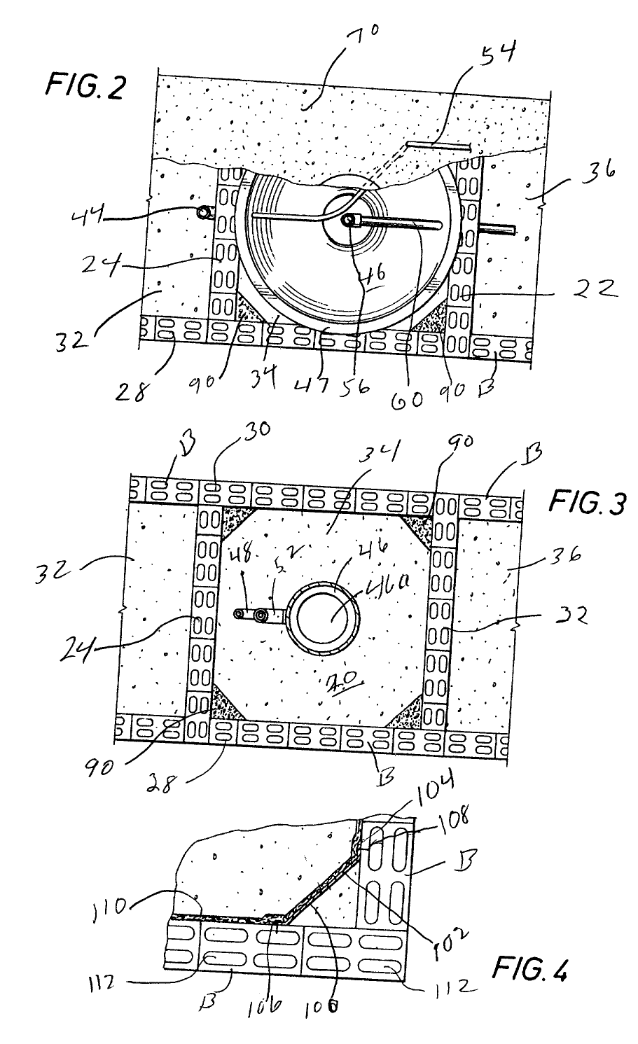

Disposed in aeration chamber 34 is a partition or hopper 46 forming a clarification chamber 48 therein; i.e., hopper 46 essentially divides aeration chamber 34 into an aeration portion outside of hopper 46 and a clarification portion inside of hopper 46. As best seen with reference to FIGS. 1 and 2, the upper end of partition 46 has an annularly extending, laterally outwardly projecting flange 47. Partition 46 and flange 47 are dimensioned such that when partition 46 is disposed in chamber 34, portions of flange 47 will rest on the upper edges of the various wall sections forming aeration chamber 34 whereby partition 46 is supported in chamber 34. An aeration source is provided generally at the intersection of base 16 and wall 24, the aeration source comprising a generally rigid tube 50 that is held by a bracket 52 to the outside of hopper 46. Rigid tubing 50 serves as a conduit for a flexible tube 54 that can be threaded through rigid tube 50, flexible tube 54 being connected to a source of oxygenated gas (not shown).

As is well known by those skilled in the art, aeration chamber 38 serves as a digestion chamber, the oxygen present in the oxygenated gas setting up an aerobic reaction wherein organic solids in the aerator are digested and converted into carbon dioxide and water; however, and as well known to those skilled in the art, in a typical wastewater treatment system such as the type under consideration, there remain solids in the aeration chamber that require further digestion for conversion into carbon dioxide and water. Accordingly, clarification chamber 48, formed interiorally of partition or hopper 46, serves as a quiescent or stilling zone wherein any solids will settle and fall out of the bottom or mouth of partition 46 to be further subjected to the aerobic action in aeration chamber 34.

Treated water essentially free of solids is transferred from clarification chamber 48 via T-head 56 and conduit 60, which extends through wall 22 and opens into holding chamber 36. With proper operation of the wastewater treatment plant 10, the water in holding chamber 36 is free of any substantial amount of solids. Moreover, by well-known methods, chlorine can be introduced into the water passing through conduit 60 such that the water in holding chamber 36 can be used for irrigation, without posing any environmental or health hazards. To this end, a pump 62 is disposed in chamber 36, pump 62 being connected to an outlet 64 from whence it can be used for irrigation or discharged into the environment, e.g., a drainage ditch or the like.

It is to be understood that chamber 36 is optional in the sense that if the system is operating properly and the water is chlorinated, the water being discharged from conduit 60 will pose no significant environmental and/or health hazard and can be discharged to a drainage ditch; however, in most instances, it is desirable that the water be reused as efficiently as possible, and accordingly, it is desirable to having a holding chamber 36 with the associated pump 62 and conduit 64 such that the water can be used for irrigation or the like.

As best seen in FIG. 1, a cover 70 overlies or covers chambers 32, 34, and 36. While cover 70 is shown as essentially a single piece, e.g., a slab of concrete or the like, it will be recognized that the cover 70 could be segmented into three sections, respective ones of said three sections covering respective ones of said chambers 32, 34, and 36. In any event, whether sectioned or in a single piece, cover 36 is provided with manholes 72, 74, and 76 to permit access into chambers 32, 34, and 36, respectively, to permit servicing as needed, e.g., pumping out sludge from chamber 32, introducing a chlorinator into clarification chamber 48, removing and/or servicing pump 62 in chamber 36, etc. In most cases, cover 70, whether of a single piece or segmented, will be sealed to the upper edges of the various wall structures forming the various chambers 32, 34, and 36 to eliminate any odors and/or spillage from any of the chambers in the event there is a malfunction and the chambers are overfilled.

As can be seen, chambers 32, 34, and 36 are generally rectilinear in cross-sectional configuration, which adds to the simplicity of construction of the walls—i.e., the laying and mortaring of the concrete blocks. Accordingly, while other cross-sectional configurations are not to be excluded, preferably, the wall structures are configured such that the chambers 32, 34, and, optionally, 36 are rectilinear in cross-sectional configuration. While unimportant in chambers 32 and 36, this rectilinear cross-sectional configuration is disadvantageous with respect to aeration chamber 34.

As is well known to those skilled in the art, the key to consistent, efficient, and reliable treatment in an aeration chamber of a wastewater treatment plant is assuring that the proper amount of oxygen is introduced for reaction with the bacteria and that there is efficient contact between the solids in the aeration chamber and the oxygen. Many factors can play a role with respect to the contact between the oxygen and the solids in the aeration chamber. Thus, the rate of oxygen introduction, the amount and direction of the movement of the liquid containing the suspended solids in the chamber, etc., are all factors to be taken into account. In an aeration chamber that is rectilinear in cross-sectional configuration, there is a strong likelihood that there will be “dead spots” in the chamber, the dead spots being zones wherein solids will accumulate and fall to the bottom of the chamber rather than being circulated in the chamber and be contacted with and hence digested. In a rectilinear chamber, these dead spots are most likely to occur at the corners of the chamber—i.e., where two intersecting side walls meet the base, e.g., where wall 24 intersects wall 28 and surface 20 of base 16. To overcome this problem and in accordance with one aspect of the present invention, fillets are provided at the intersection of adjacent wall structures.

With reference then to FIG. 5, there is shown a fillet 80 that is essentially a four-sided pyramid that can be constructed of concrete or the like and that engages the surface 20 of base 16, a portion of the inside surface of a wall, e.g., wall 24, and a portion of the inside surface of an adjacent wall, e.g., wall 28. As can be seen, fillet 80 has a triangular-shaped surface 82 that faces inwardly into chamber 34 and would prevent settling of solids in the corner formed by the intersection of walls 24, 28, and surface 20 of base 16. Largely, surface 82 eliminates a dead spot at the above-described intersection and thereby aids in maintaining circulation of the solids in the aeration chamber 34.

With reference next to FIGS. 1, 3, and 6, there is shown another embodiment of the present invention employing a different fillet. As best seen in FIG. 6, fillet 90 is generally triangular when viewed in transverse cross-section and has a surface that engages one wall forming chamber 34 and an adjacent wall forming chamber 34, and also provides a surface 92 that faces into chamber 34. As best seen with reference to FIG. 3, when installed in all four corners of chamber 34, the cross-sectional configuration of chamber 34 begins to approximate a circle that is ideally the configuration one would desire to achieve maximum circulation, minimization of dead spots, and hence maximum contact of oxygen with the circulating solids in the aeration chamber. It will be understood that fillet 90 can be made of concrete, mortar, or some other such material and can be easily and manually installed in chamber 34. Fillet 90 is superior to fillet 80 in the sense that surface 92 extends for a vertical height in chamber 34 to a point at least above the liquid level therein, and, accordingly, there are no right-angle corners that can interfere with circulation in aeration chamber 34.

With reference now to FIG. 4, there is shown yet another fillet form that can be employed. Fillet 100, which as fillet 90 can extend substantially the full vertical height of chamber 34 if desired, is comprised of a substantially flat panel 102 with laterally extending flanges 104 and 106 on either side. As can be seen, flanges 104 and 106 provide a surface by which fillet 100 can be attached to adjacent vertical walls by means of fasteners 108. As fillet 90, fillet 100 forms essentially a 45° angle with the adjacent, intersecting walls, forming a corner of chamber 34, and thus provides a cross-sectional configuration that, as shown in FIG. 3, approximates to some extent a circle. It will be appreciated that preferably fillet 100 will be sealed along its bottom edge—i.e., where it engages base 16—so as to prevent the accumulation of any solids in the space laterally outwardly of panel 102. FIG. 4 also demonstrates another feature of the present invention. Although for the most part concrete blocks and mortar can be considered water-impervious, flaws in forming the concrete blocks or in constructing the walls can lead to seepage through the walls. To overcome this problem, the inner surface of all the walls forming all of the chambers can be coated with a layer or coating 110 of a sealant, such as asphalt, epoxy, or various other materials, that can be spread in a relatively thin layer over the inner surfaces of the walls and that forms a water-impervious liner. It will be understood that liner 110 can be applied to the inner surfaces forming all of the chambers or selected chambers, as desired. As seen in FIG. 4, layer 110 is ideally laid over the inner surface of fillet 100 to prevent any water from entering the space outwardly of fillet 100. Once again, it will be understood that fillet 100 would be installed in all four corners of chamber 34, as in the manner with fillets 80 and 90.

As is well known, concrete blocks of the type used in the method and wastewater treatment plant of the present invention commonly have holes therethrough, such as holes 112, which reduce the materials of construction and aid in handling of the concrete blocks B. If desired, the holes 112 can be filled with concrete as the blocks are being laid to impart greater structural integrity.

It can be seen from the above that the wastewater treatment plant and method of construction thereof is ideally suited for providing wastewater treatment plants at remote sites where manual labor and raw materials for making cement, concrete blocks, mortar, and the like may be plentiful, or at least readily accessible, but where equipment for transporting bulky or heavy objects or equipment for handling such is not available. The base, the concrete blocks, the mortar, any concrete or cement used to make the fillets or covers can be readily made at the site of use, for the large part employing only manual labor. Thus, the base can be formed, if necessary, by laying a form, hand-mixing concrete, and pouring it into the form until a base of desired dimensions is achieved. In like fashion, the concrete blocks can be made at site. The building of the walls forming the various chambers is a skill common to many residents of underdeveloped countries. The partition or hopper used in the aeration chamber 34 is generally made of fiberglass or some similar plastic-like material and accordingly, is relatively lightweight and, except in extremely large systems, can be easily, manually handled. Obviously any pumps and piping employed can be easily handled and installed manually. Because of the configuration of the hoppers, e.g., hopper 46, they can be nested, and thus a number of hoppers can be shipped at minimum cost and easily transported to a site for multiple installations.

The foregoing description and examples illustrate selected embodiments of the present invention. In light thereof, variations and modifications will be suggested to one skilled in the art, all of which are in the spirit and purview of this invention.

1. A wastewater treatment plant comprising:
a base forming a floor surface;
a first wall having an upper edge and an inner surface and supported on said base;
a second wall having an upper edge and an inner surface and supported on said base, said second wall being spaced from said first wall;
an intermediate partition wall having an upper edge, a first surface, and a second surface and supported on said base, said partition wall being disposed between said first wall and said second wall;
a first side wall having an upper edge and an inner surface and supported on said base, said first side wall extending between said first wall and said second wall and sealingly connected to said first wall, said second wall, and said partition wall;
a second side wall having an upper edge and an inner surface and supported on said base, said second side wall extending between said first wall and said second wall and sealingly connected to said first wall, said second wall, and said partition wall;
a settling chamber being formed by a portion of said floor surface, said first wall, said partition wall, and portions of said first and second side walls;
an aeration chamber being formed by a portion of said floor surface, said second wall, said partition wall, and portions of said first and second side walls;
said first wall, said second wall, said partition wall, and said side walls being constructed of concrete blocks and mortar;
a cover overlying said first and second chambers;
an inlet into said first chamber;
a conduit providing open communication between said first chamber and said second chamber;
an aeration source disposed in said second chamber adjacent an intersection of a portion of said floor surface and said partition wall;
a partition disposed and supported in said aeration chamber, said partition forming a clarification chamber therein and defining an inverted frustoconical surface, said partition having an upper end and a lower end, said lower end defining an open mouth facing said floor surface; and
an outlet from said clarification chamber.

2. A method of constructing a wastewater treatment plant comprising:
installing a base, said base providing an upwardly facing, generally horizontal floor surface;
installing a first, generally vertically extending wall on said base, said first wall having an inner surface and an upper edge;
installing a second, generally vertically extending wall on said base, said second wall having an inner surface and an upper edge being spaced from said first wall;
installing on said base an intermediate partition wall disposed between said first wall and said second wall;
installing a first side wall on said base, said first side wall having an inner surface and an upper edge extending between said first end wall and said second wall and being sealingly connected to said first end wall, said second wall, and said partition wall;
installing a second side wall on said base, said second side wall having an upper surface and an upper edge and extending between said first end wall and said second wall and being sealingly connected to said first end wall, said second wall, and said partition wall;
said first wall, said second wall, said partition wall, and said side walls being constructed of concrete blocks and mortar, a settling chamber being formed by a portion of said base, said first wall, said partition wall, and portions of said first and second side walls, an aeration chamber being formed by a portion of said base, said second wall, said partition wall, and portions of said first and second side walls;
providing an inlet into said first chamber;
providing open communication between said settling chamber and said aeration chamber;
providing an aeration source in said aeration chamber adjacent an intersection of said base and said partition wall;
disposing and supporting a partition in said aeration chamber, said partition forming a clarification chamber therein and defining an inverted frustoconical surface, said partition having a lower end and an upper end, said partition having an open mouth portion facing said floor surface;
providing an outlet from said clarification chamber; and
installing a cover over said settling and aeration chambers.
